(19) United States
(12) Patent Application Publication
(10) Pub. No.: US 2025/0258684 A1
(43) Pub. Date: Aug. 14, 2025

(54) Electronic Devices, Systems, and Corresponding Methods for Utilizing User Sensory Preference Reaction Scores to Enhance User Interface Interactions

(71) Applicant: Motorola Mobility LLC, Chicago, IL (US)

(72) Inventors: Amit Kumar Agrawal, Bangalore (IN); Krishnan Raghavan, Bangalore (IN); Hariprasad Shanbhogue Alampady, Bangalore (IN)

(21) Appl. No.: 18/438,594

(22) Filed: Feb. 12, 2024

(51) Int. Cl. G06F 9/451

(52) U.S. Cl. CPC G06F 9/451

(57) ABSTRACT

An electronic device includes a communication device and one or more processors operable with the communication device. The one or more processors are configured to, in response to the communication device determining that a remote electronic device in communication with the communication device across a network is implementing a sensory element user interface presentation mode of operation, compile a plurality of user interface sensory element configurations contained in a user interface sensory element bundle from which a user interface sensory element configuration can be selected as a function of a dominant sensory profile associated with an authorized user of the electronic device, and cause the communication device to transmit the user interface sensory element bundle to the remote electronic device across the network.

### BACKGROUND

### Technical Field

This disclosure relates generally to electronic devices, and more particularly to electronic devices having user interfaces.

### Background Art

Portable electronic device usage has become ubiquitous. Vast majorities of the population carry a smartphone, tablet computer, or laptop computer daily to communicate with others, stay informed, to consume entertainment, and to manage their lives.

As the technology incorporated into these portable electronic devices has become more advanced, so too has their feature set. A modern smartphone includes more computing power than a desktop computer of only a few years ago. Additionally, while early generation portable electronic devices included physical keypads, most modern portable electronic devices include touch-sensitive displays. While such improvements to user interfaces are beneficial, each electronic device user is different from another. As such, a singular user interface may not be optimized for all users. It would be advantageous to have an improved electronic device with improved user interface capabilities so as to better fit the needs of all users.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory server complex in accordance with one or more embodiments of the disclosure.

FIG. 3 illustrates one explanatory method in accordance with one or more embodiments of the disclosure.

FIG. 4 illustrates one or more method steps in accordance with one or more embodiments of the disclosure.

FIG. 5 illustrates another explanatory method in accordance with one or more embodiments of the disclosure.

FIG. 6 illustrates still another explanatory method in accordance with one or more embodiments of the disclosure.

FIGS. 7-12 illustrate different user interface presentations created as a function of dominant sensory profiles in accordance with one or more embodiments of the disclosure.

FIG. 13 illustrates one explanatory system in accordance with one or more embodiments of the disclosure.

FIG. 14 illustrates various embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to determining, with a communication device, that an electronic device is in communication across a network with a remote electronic device implementing a sensory element user interface presentation mode of operation, constructing a user interface sensory element bundle, and pushing, with the communication device, transmission of the user interface sensory element bundle to the remote electronic device. Similarly, in a receiving electronic device, it should be observed that the embodiments reside primarily in a combination of method steps and apparatus components related to receiving, by a communication device from a remote electronic device across a network, a user interface sensory element bundle, identifying, by one or more sensors of the electronic device, a user using the electronic device, determining, by the one or more processors, a dominant sensory profile associated with the user of the electronic device, selecting, by the one or more processors, a user interface sensory element configuration from the user interface sensory element bundle as a function of the dominant sensory profile, and presenting, by the one or more processors on a user interface of the electronic device, the user interface sensory element configuration selected from the user interface sensory element bundle. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in a sending device in response to the communication device determining that a remote electronic device in communication with a communication device of an electronic device across a network is implementing a sensory element user interface presentation mode of operation, compiling a plurality of user interface configurations contained in a user interface sensory element bundle from which a user interface sensory element configuration can be selected as a function of a dominant sensory profile associated with an authorized user of the electronic device, and causing the communication device to transmit the user interface sensory element bundle to the remote electronic device across the network. It will further be appreciated that embodiments of the disclosure described herein may be comprised of one or more conventional processors and unique stored program instructions that control the one or more processors to implement, in conjunction with certain non-processor circuits, some, most, or all of the functions of, in a receiving device, selecting a user interface sensory element configuration from a plurality of user interface sensory element configurations contained in a user interface sensory element bundle received by a communication device from a remote electronic device across a network as a function of a dominant sensory profile associated with an authorized user of the electronic device and, thereafter, causing the user interface of the electronic device to present the user interface sensory element configuration selected from the plurality of user interface sensory element configurations contained in the user interface sensory element bundle. The non-processor circuits may include, but are not limited to, a radio receiver, a radio transmitter, signal drivers, clock circuits, power source circuits, and user input devices.

As such, these functions may be interpreted as, in a sending device, steps of a method to perform the creation, using one or more processors of an electronic device, of a plurality of user interface sensory element configurations each enhancing a different sensory appearance when rendered on an electronic device, writing, by the one or more processors, an enhanced sensory appearance to metadata of each user interface sensory element configuration of the plurality of user interface sensory element configurations, compiling, by the one or more processors, the plurality of user interface sensory element configurations into a user interface sensory element bundle, and pushing, by a communication device, the user interface sensory element bundle to one or more remote electronic devices across a network. Alternatively, in a receiving device, these functions may be interpreted as presenting, by one or more processors on a user interface of an electronic device, a plurality of user interface elements, with each user interface element of the plurality of user interface elements including components catering to different sensory perceptions from other user interface elements of the plurality of user interface elements, measuring, by one or more sensors of the electronic device, reactions of a user of the electronic device to the plurality of user interface elements, determining, by the one or more processors from the reactions, a user sensory preference reaction score, and, thereafter, receiving, by a communication device from a remote electronic device across a network, a user interface sensory element bundle, selecting, by the one or more processors, a user interface sensory element configuration from the user interface sensory element bundle as a function of the user sensory preference reaction score, and presenting, by the one or more processors on the user interface, the user interface sensory element configuration selected from the user interface sensory element bundle. It will be obvious to those of ordinary skill in the art having the benefit of this disclosure that some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Sensory branding is a concept sometimes used in marketing campaigns where marketing copy is designed to appeal to different—or all—senses in relation to a particular brand. Sensory branding uses the senses to relate to customers on an emotional level.

Some believe that the difference between products consumers consider to be “ordinary” suddenly become “captivating” products when the emotion of sensory branding is added. When such “emotion” is integrated into marketing copy, products and services seem to “shine” more to prospective customers. When this “emotion” is absent, potential customers can lack the enthusiasm and passion that is required to launch a product or service into the atmosphere of success.

Embodiments of the disclosure contemplate that owners of brands can forge emotional associations in the minds of potential customers by appealing to their senses. Indeed, a multi-sensory brand experience can beneficially generate certain beliefs, feelings, thoughts, and opinions to create a sensory image in the minds of those potential customers.

Embodiments of the disclosure also contemplate that the benefit of appealing to a person's senses can also be integrated into the user interface experiences provided by an electronic device. Said differently, embodiments of the disclosure contemplate that processors, sensors, and other components of an electronic device, such as a smartphone, can be configured to increase the pleasure, usage, excitement, and richness of the user interface experience. When user interfaces are configured to provide experiences in accordance with user sensory preference reaction scores or dominant sensory profiles configured in accordance with embodiments of the disclosure, users can even be prompted to recommend those user interfaces to others so that others can share in the joy of the rich sensory experiences.

Embodiments of the disclosure contemplate that sensory-focused experiences cater to the five senses of human beings, namely, sight, sound, touch, smell, and taste. Marketers and other companies are increasingly competing with each other to make their branding and advertising experiences sensory-focused. In multi-media environments, these companies increasingly use rich animations, music, and motion to appeal to users. While such user experiences can produce positive responses, they introduce to problematic issues: sensory overload/deprivation and lack of personalization.

While sensory branding can advantageously appeal to each of the senses of a user, embodiments of the disclosure contemplate that overloading one particular sense, or trying to stimulate all the senses at once, can lead to overstimulation. In turn, this overstimulation may result in the exact opposite of the effect desired, namely, less interest and engagement. To compensate, embodiments of the disclosure contemplate that certain brands present sensory overload experiences. However, this can lead to sensory deprivation leading to extremely low stimulation from the sensory branding. In short, users tend to get bored when there is no sensory value addition.

While companies frequently use sensory branding, the senses targeted by this branding reflects the company or brand and not the user. Illustrating by example, a coffee shop may create a user experience centered around aroma to appeal to a user's sense of smell. However, trying to appeal to this particular sense with each and every user may backfire when certain people are not “smell” centered when it comes to the five senses. Said differently, embodiments of the disclosure contemplate that sensory branding generally lacks personalization.

From these conclusions, it becomes evident that it would be advantageous to be able to personalize branding campaigns and corresponding user experiences to adapt to user preferences with particularity rather than delivering generic experiences. Embodiments of the disclosure contemplate that the stimulations that cater to different senses are not mutually exclusive. To the contrary, some users may enjoy having all five senses stimulated while other users may prefer only a few and may dislike more than that receiving stimulation. With prior art electronic devices and user interfaces, there is no way for companies and other content creators to understand how each individual user will react to sensory stimulation. Embodiments of the disclosure advantageously help such companies and content creators to know just this information so that they can target such users with specific user interface experiences that cater to their preferred sensory experiences.

To solve these problems, embodiments of the disclosure provide systems and methods where one or more processors of an electronic device configured to operate in a sensory element user interface presentation mode of operation determine a user sensory preference reaction score to create a dominant sensory profile associated with a user. Thereafter, a remote electronic device, such as a server complex, can construct, using one or more processors, a user interface sensory element bundle and can push the user interface sensory element bundle to the electronic device across a network using a communication device. The electronic device, after receiving the user interface sensory element bundle, can identify, using one or more sensors, a user of the electronic device and can determine, using the one or more processors, the dominant sensory profile associated with the user. The one or more processors can then select a user interface sensory element configuration from the user interface sensory element bundle as a function of the dominant sensory profile associated with the user, and can present, by the one or more processors on the user interface of the electronic device, the user interface sensory element configuration selected from the user interface sensory element bundle.

Accordingly, in one or more embodiments, a method in a sending electronic device in communication with another electronic device configured to operate in a sensory element user interface presentation mode of operation comprises determining, with a communication device of the electronic device, that the electronic device is in communication, across a network, with at least one remote electronic device implementing a sensory element user interface presentation mode of operation. In one or more embodiments, the method comprises constructing, with the one or more processors, a user interface sensory bundle. In one or more embodiments, the user interface sensory element bundle comprises a plurality of user interface sensory element configurations.

In one or more embodiments, the one or more processors encode a dominant sensory profile into the metadata of each user interface sensory element configuration contained in the user interface sensory element bundle. In one or more embodiments, the method comprises pushing, with the communication device, transmission of the user interface sensory element bundle to at least one remote electronic device.

From the receiving device, a method comprises receiving, by a communication device from a remote electronic device across a network, the user interface sensory element bundle. One or more sensors can then identify a user of the electronic device, while one or more processors determine a dominant sensory profile associated with the identified user. The one or more processors can then select a user interface sensory element configuration from the user interface sensory element bundle as a function of the dominant sensory profile associated with the user of the electronic device and cause a user interface of the electronic device to present the user interface sensory element configuration selected from the user interface sensory element bundle.

Advantageously, this allows one or more processors of the receiving electronic device to select a user interface sensory element configuration having a dominant sensory profile corresponding to the sensory element preferences of the user of the electronic device. Thus, if the user is eye-minded, the one or more processors of the user's device can select an eye-minded user interface sensory element configuration. If the user is smell-minded, the one or more processors of the user's device can select a smell-minded user interface sensory element configuration. If the user is aurally minded, the one or more processors can select an ear-minded user interface sensory element configuration. If the user is gustatorily motivated, the one or more processors can select a taste-minded user interface sensory element configuration. If the user prefers tactile experiences, the one or more processors can select a motor-minded user interface sensory element configuration from the bundle. The selected user interface sensory element configuration can then be presented on a user interface of the user's device to provide a rich, satisfying user interface experience.

In one or more embodiments, either the sending electronic device or the receiving can determine the sensory preference of the user by calculating a user sensory preference reaction score for the user. In one or more embodiments, a method in an electronic device helps to identify the dominant sensory profile of each user of an electronic device. In one or more embodiments, the dominant sensory profile is associated with one or more senses that each user of the electronic device preferably responds.

In one or more embodiments, this happens in the user device. Illustrating by example, in one or more embodiments a method in an electronic device helps to identify the dominant sensory profile of each user of an electronic device. In one or more embodiments, the dominant sensory profile is associated with one or more senses that each user of the electronic device preferably responds.

In one or more embodiments, to determine the dominant sensory profile, one or more sensors of the electronic device monitor a user's interactions with the user interface of the electronic device and, optionally, also with any connected companion devices. The one or more sensors of the electronic device use a variety of parameters to determine a, from detected reactions to a plurality of user interface elements presented on a user interface, a user sensory preference reaction score.

In one or more embodiments, the user sensory preference reaction score defines a measurement of sensory responses for each sense of each user. In one or more embodiments, one or more processors can provide options for refining the user sensory preference reaction score as well. In one or more embodiments, the user sensory preference reaction scores are used to appropriately segment users into those that respond to, for example, visual stimuli, aural stimuli, smells, touch, and so forth.

In one or more embodiments, methods in electronic devices identify high dominance and low dominance factors for each sense using one or more sensors that measure reactions of a user of an electronic device to user interface elements presented on a user interface of the electronic device. In one or more embodiments, one or more processors then determine, from the reactions, the user sensory preference reaction score. Illustrating by example, if a user is always wearing a noise-canceling headset—even when no music is playing—the ear-minded dominance score component of the user sensory preference reaction score may be diminished.

In one or more embodiments, the user sensory preference reaction score is determined using an ear-minded dominance score, an eye-minded dominance score, a smell-minded dominance score, a taste-minded dominance score, and a motor-minded dominance score. In one or more embodiments, each score can be multiplied by a weighting factor since not all scores are necessarily equal. Illustrating by example, a noise canceling headset factor may have a different weighting factor (higher or lower) compared to another factor associated with whether the user tends to enhance audio output with stereo, surround, or other effects.

In one or more embodiments, the scores can then be summed. In one or more embodiments, one or more processors of the electronic device normalize the eye-minded dominance score, the smell-minded dominance score, the ear-minded dominance score, the taste-minded dominance score, and the motor-minded dominance score to have a value between one and negative one, inclusive. To ensure that each normalized user sensory preference reaction score can be customized as desired by a user, in one or more embodiments one or more processors present the user sensory preference reaction score on a user interface. Users can deliver user input to the user interface to adjust one or more processors sensory preference elements of the user sensory preference reaction score as a function of this user input.

Accordingly, in one or more embodiments a method in an electronic device comprises presenting, by one or more processors on a user interface, a plurality of user interface elements. In one or more embodiments, each user interface element of the plurality of user interface elements includes components catering to different sensory perceptions from other user interface elements of the plurality of user interface elements.

Thereafter, one or more sensors of the electronic device can measure reactions of a user of the electronic device to the plurality of user interface elements. In one or more embodiments, one or more processors of the electronic device then determine the user sensory preference reaction score from these measured reactions. The one or more processors can then associate the user sensory preference reaction score with a dominant sensory profile associated with a user of the electronic device and can store that dominant sensory profile in a memory of the electronic device. The method can be repeated as different users use the electronic device.

In one or more embodiments, an electronic device comprises a user interface, a memory, one or more sensors, and one or more processors operable with the user interface, the memory, and the one or more sensors. In one or more embodiments, the one or more processors are configured to, when the one or more sensors identify an authorized user of the electronic device using the electronic device, to determine a dominant sensory profile associated with the authorized user and store the dominant sensory profile associated with the authorized user in the memory of the electronic device.

In one or more embodiments, to determine the dominant sensory profile, one or more sensors of the electronic device monitor a user's interactions with the user interface of the electronic device and, optionally, also with any connected companion devices. The one or more sensors of the electronic device use a variety of parameters to determine, from detected reactions to a plurality of user interface elements presented on a user interface, a user sensory preference reaction score. In one or more embodiments, the user sensory preference reaction score defines a measurement of sensory responses for each sense of each user. In one or more embodiments, one or more processors can provide options for refining the user sensory preference reaction score as well. In one or more embodiments, the user sensory preference reaction scores are used to appropriately segment users into those that respond to, for example, visual stimuli, aural stimuli, smells, touch, and so forth.

In one or more embodiments, once the user sensory preference reaction score or dominant sensory profile is defined, a method in an electronic device such as a server complex in communication with one or more remote electronic devices, creates, using one or more processors, a plurality of user interface sensory element configurations each enhancing a different sensory appearance when rendered on the one or more remote electronic devices. In one or more embodiments, the one or more processors them write an enhanced sensory appearance to metadata of each user interface sensory element configuration of the plurality of user interface sensory element configurations.

In one or more embodiments, the one or more processors then compile the plurality of user interface sensory element configurations into a user interface sensory element bundle. A communication device of the electronic device can then push the user interface sensory element bundle to the one or more remote electronic devices across a network. Those remote electronic devices can then use their processors to read the metadata and then select a user interface sensory element configuration corresponding to the sensory preferences of a user of the electronic device.

In one or more embodiments, the user's device, which is in communication with the server complex and includes a user interface, a communication device, and one or more processors can, in response to receiving the user interface sensory element bundle, select a user interface sensory element configuration from the plurality of user interface sensory element configurations contained in the user interface sensory element bundle as a function of the dominant sensory profile. Thereafter, the one or more processors can cause the user interface to present the selected user interface sensory element configuration from the plurality of user interface sensory element configurations contained in the user interface sensory element bundle.

In one or more embodiments, in a sending device, the sending device determines that at least one electronic device in communication with the sending device across a network implements a sensory element user interface presentation mode of operation. In one or more embodiments, the sending device encodes into metadata associated with the content, a content consumption criterion related to at least one dominant sensory profile of consumers of the content. Indeed, the sending device can generate multiple copies of the content, each catering to different sensory perceptions identified and encoded into the metadata associate with the content. Each new copy of the content can cater to a different set of sensory perceptions than another.

Illustrating by example, a first user interface sensory element configuration of the plurality of user interface sensory element configurations contained in the user interface sensory element bundle is enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device, and so forth. In one or more embodiments, each user interface sensory element configuration created of the content can cater to a different sensor profile related to hearing, sight, smell, touch, and taste.

In one or more embodiments, the sending device then delivers a user interface sensory element bundle containing all of the content items in the form of user interface sensory element configurations to a receiving device. This allows one or more processors of the receiving device to select one of the user interface sensory element configurations as a function of the dominant sensory profile of a user identified using the electronic device and render that selected user interface sensory element configuration on a user interface of the receiving device.

From the receiving device's perspective, the receiving device receives the user interface sensory element bundle from the sending device. In one or more embodiments, the user interface sensory element bundle includes a notification that content in the form of a plurality of user interface sensory element configurations is available for presentation on a user interface of the electronic device. One or more processors of the receiving electronic device can determine to which sensory elements each user interface sensory element configuration caters by reading the metadata of each user interface sensory element configuration in the user interface sensory element bundle.

One or more sensors of the receiving electronic device can then determine the current user of the electronic device. The one or more processors can then select the appropriate user interface sensory element configuration from the user interface sensory element bundle as a function of the dominant sensory profile associated with the user and can cause that user interface sensory element configuration to be presented on a user interface of the electronic device. When the electronic device is being used by another user, the process can repeat such that each user of the electronic device interacts with a user interface sensory element configuration catering to their preferred sensory experiences.

Thus, in one or more embodiments, a sending electronic device comprises a communication device and one or more processors operable with the communication device. In one or more embodiments, the one or more processors are configured to, in response to the communication device determining that a remote electronic device is in communication with the communication device across a network and the remote electronic device is implementing a sensory element user interface presentation mode of operation, compiling a plurality of user interface sensory element configurations contained in a user interface sensory element bundle from which a user interface sensory element configuration can be selected as a function of a dominant sensory perception associated with an authorized user of the electronic device. In one or more embodiments, the one or more processors cause the communication device to transmit the user interface sensory element bundle to the remote electronic device across the network.

Correspondingly, a receiving electronic device can comprise a user interface, a communication device, and one or more processors operable with the user interface and the communication device. In one or more embodiments, the one or more processors are configured to select a user interface sensory element configuration from a plurality of user interface sensory element configurations contained in a user interface sensory element bundle received by the communication device from the sending device across a network. In one or more embodiments, this selection occurs as a function of a dominant sensory profile associated with an authorized user of the electronic device. Thereafter, the one or more processors can cause the user interface sensory element configuration selected from plurality of user interface sensory element configurations contained in the user interface sensory element bundle.

Accordingly, if a user is an eye-minded user, the user interface sensory element configuration selected may say, “Feast your eyes on the mesmerizing new RAZR.sup.™ ULTRA, a sight to behold! Get lost in its sleek lines, vibrant display, and stunning visuals that will transport you to a world of unrivaled beauty.” By contrast, for an aurally minded user, the user interface sensory element configuration selected may say, “Listen to the symphony of innovation with the new RAZR.sup.™ ULTRA. Immerse yourself in a melodic blend of crisp audio, powerful beats, and crystal-clear sound, as every note and rhythm come to life, taking your auditory experience to unprecedented heights.” For the tactile-minded person, the selected user interface sensory element configuration may say, “Experience the new RAZR.sup.# ULTRA like never before, as it envelops you in a world of tactile marvels. Feel the satisfying click of the slick keypad, the gentle vibrations of every touch, and the smooth glide of your fingers, creating an immersive haptic sensation that brings technology to life.” These examples of user interface sensory element configurations are illustrative only as others will be obvious to those of ordinary skill in the art having the benefit of this disclosure.

For example, if a person is taste-minded, the selected user interface sensory element configuration may say, “Savor the flavors of technology with the new RAZR.sup.™ ULTRA—indulge your senses with a delectable blend of cutting-edge features and innovation that will leave you craving for more—just like a fine dining experience, the RAZR.sup.™ ULTRA offers a taste of elegance and sophistication that will satisfy your tech cravings.” For the smell-minded user, the selected user interface sensory element configuration may say, “Immerse yourself in a world of captivating scents with the new RAZR.sup.™ ULTRA—as you unbox the device, a delightful aroma of fresh technology fills the air, signaling the beginning of an extraordinary journey—with every touch and swipe, you'll be enveloped in a scent of refinement, reminiscent of the finest craftsmanship, making the RAZR.sup.™ ULTRA a truly sensorial experience.”

Advantageously, embodiments of the electronic device allow for the transmission of multiple user interface sensory element configurations in a user interface sensory element bundle, with each user interface sensory element configuration catering to a different sensory perception or combination of sensory perceptions. One or more processors of the receiving device can then select and surface a user interface sensory element configuration corresponding to a dominant sensory profile of a user using the electronic device to provide sensory stimuli catering to the user's personal preferences. Moreover, embodiments of the disclosure allow each user to have a personalized sensory experience tailored to their preferences.

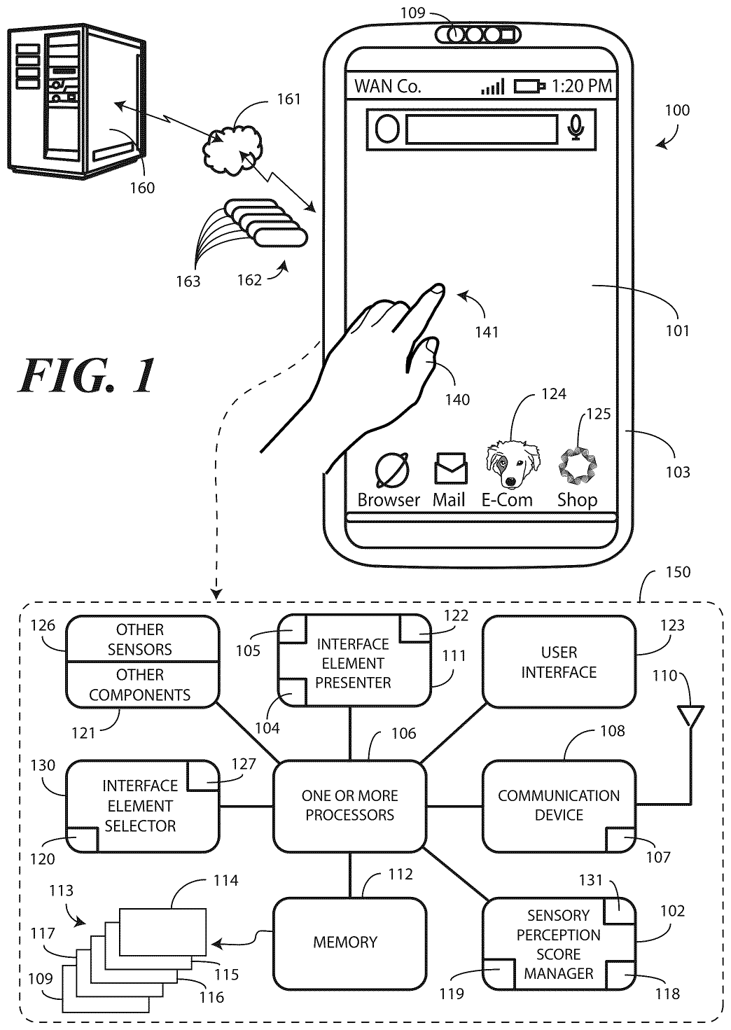

Turning now to FIG. 1, illustrated therein is one electronic device 100 configured in accordance with one or more embodiments of the disclosure. The electronic device 100 of this illustrative embodiment includes a user interface 123. In one or more embodiments, the user interface 123 comprises a display 101, which may optionally be touch-sensitive. The display 101 can serve as a primary user interface 123 of the electronic device 100.

Where the display 101 is touch sensitive, users can deliver user input to the display 101 by delivering touch input from a finger, stylus, or other objects disposed proximately with the display. In one embodiment, the display 101 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 100 of FIG. 1 includes a housing 103. Features can be incorporated into the housing 103. Examples of features that can be included along the housing 103 include an imager 109, shown as a camera in FIG. 1, or an optional speaker port. A user interface component, which may be a button or touch sensitive surface, can also be disposed along the housing 103.

A block diagram schematic 150 of the electronic device 100 is also shown in FIG. 1. In one embodiment, the electronic device 100 includes one or more processors 106. In one embodiment, the one or more processors 106 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more Application Specific Integrated Circuits (ASICs), programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 112, can optionally store the executable software code used by the one or more processors 106 during operation.

In this illustrative embodiment, the electronic device 100 also includes a communication device 108 that can be configured for wired or wireless communication with one or more other devices or networks. The networks can include a wide area network, a local area network, and/or personal area network. The communication device 108 may also utilize wireless technology for communication, such as, but are not limited to, peer-to-peer, or ad hoc communications such as HomeRF, Bluetooth and IEEE 802.11 based communication, or alternatively via other forms of wireless communication such as infrared technology. The communication device 108 can include wireless communication circuitry, one of a receiver, a transmitter, or transceiver, and one or more antennas 110. In the illustrative embodiment of FIG. 1, the electronic device 100 is shown electronically in communication with a server complex 160 across a network 161.

The electronic device 100 can optionally include a near field communication circuity 107 used to exchange data, power, and electrical signals between the electronic device 100 and another electronic device. In one embodiment, the near field communication circuity 107 is operable with a wireless near field communication transceiver, which is a form of radio-frequency device configured to send and receive radio-frequency data to and from the companion electronic device or other near field communication objects.

Where included, the near field communication circuity 107 can have its own near field communication circuit controller in one or more embodiments to wirelessly communicate with companion electronic devices using various near field communication technologies and protocols. The near field communication circuity 107 can include—as an antenna—a communication coil that is configured for near-field communication at a particular communication frequency. The term “near-field” as used herein refers generally to a distance of less than about a meter or so. The communication coil communicates by way of a magnetic field emanating from the communication coil when a current is applied to the coil. A communication oscillator applies a current waveform to the coil. The near field communication circuit controller may further modulate the resulting current to transmit and receive data, power, or other communication signals with companion electronic devices.

In one embodiment, the one or more processors 106 can be responsible for performing the primary functions of the electronic device 100. For example, in one embodiment the one or more processors 106 comprise one or more circuits operable to present presentation information, such as images, text, and video, on the display 101. In one or more embodiments, this information can be specifically tailored to a user sensory preference reaction score 118 and/or a dominant sensory profile 119 associated with an authorized user of the electronic device 100.

Illustrating by example, in one or more embodiments a sensory perception score manager 102 is operable to present, on the user interface 123, a plurality of user interface elements 131. In one or more embodiments, each of the plurality of user interface elements 131 includes components catering to different sensory perceptions from other user interaction events of the plurality of user interface elements 131.

For instance, in one or more embodiments the plurality of user interface elements 131 comprises text, with at least one user interface element enhancing a characteristic associated with at least one user sensory element and diminishing another characteristic associated with at least one other user sensory element. If a basic user sensory element was an advertisement for fried chicken from Buster's Chicken Shack, when that user sensory element was configured to enhance a sight characteristic, touch characteristic, and sound characteristic, while diminishing a smell characteristic and taste, the advertisement may read “See Buster's Chicken Glisten as the beautifully crisped crust crackles in your fingers.” By contrast, if the user sensory element was configured to enhance taste and smell, while diminishing sight, touch, and sound, the advertisement may read, “Blind tasters instantly recognize that heavenly aroma, even before the succulent juices reach their lips,” and so forth.

Accordingly, by presenting this plurality of user interface elements 131 and measuring reactions, the sensory perception score manager 102 can not only calculate the user sensory preference reaction score 118 of the authorized user 140 of the electronic device 100, but also associate that user sensory preference reaction score 118 with a dominant sensory profile 119 associated with the authorized user 140 of the electronic device 100. The sensory perception score manager 102 can then store the dominant sensory profile 119 in the memory 112 of the electronic device 100.

When new users begin using the electronic device 100, the sensory perception score manager 102 can detect, using the one or more sensors 126, another user using the electronic device 100. In one or more embodiments, the sensory perception score manager 102 then repeats the presentation of the plurality of user interface elements 131, measures the reactions of the other user to the plurality of user interface elements 131, and determines, from those reactions, another user sensory preference reaction score 118. Thus, multiple users can each have a personalized user sensory preference reaction score 118 and corresponding dominant sensory profile 119.

In one or more embodiments, the sensory perception score manager 102 then measures, using one or more sensors 126 of the electronic device 100, reactions of a user of the electronic device 100 to the plurality of user interface elements 131. In one or more embodiments, the sensory perception score manager 102 then determines a user sensory preference reaction score 118 from the reactions to the plurality of user interface elements 131. Moreover, when the one or more sensors 126 identify an authorized user of the electronic device 100 using the electronic device 100, the sensory perception score manager 102 can determine a dominant sensory profile 119 associated with the authorized user. The dominant sensory profile 119 can be stored in the sensory perception score manager 102, in the memory 112, or elsewhere.

In one or more embodiments, the communication device 108 is operable to receive, from a remote electronic device such as the server complex 160 across a network, a user interface sensory element bundle 162. In one or more embodiments, the user interface sensory element bundle 162 comprises a plurality of user interface sensory element configurations 163. In one or more embodiments, the plurality of user interface sensory element configurations 163 comprise an eye-minded user interface sensory element configuration, a smell-minded user interface sensory element configuration, an ear-minded user interface sensory element configuration, a taste-minded user interface sensory element configuration, and a motor-minded user interface sensory element configuration.

In one or more embodiments, the plurality of user interface sensory element configurations 163 each comprise informational components comprising text 127. In one or more embodiments, the text 127 of each user interface sensory element configuration 163 has one or both of adjectives and/or adverbs in the text that differs from each other user interface sensory element configuration of the plurality of user interface sensory element configurations 163, with those one or both of the adjectives and/or the adverbs enhancing a characteristic associated with at least one user interface element and diminishing another characteristic associated with at least one other user interface element. In one or more embodiments, one or both of the adjectives and/or the adverbs are encoded into metadata associated with each sensory element configuration.

Thereafter, one or more sensors 126 of the electronic device 100 can identify a user 140 of the electronic device 100. An interface element selector 130 can then determine the dominant sensory profile 119 associated with the user 140 of the electronic device 100. In one or more embodiments, this comprises retrieving, by the interface element selector 130, the user sensory preference reaction score 118 from a user profile stored in the memory 112 or the sensory perception score manager 102.

In one or more embodiments, the interface element selector 130 can then select a user interface sensory element configuration 120 from the user interface sensory element bundle 162 as a function of the dominant sensory profile 119. In one or more embodiments, the user interface sensory element configuration 120 selected from the user interface sensory element bundle 162 comprises one or more of user input controls 104, navigational elements 105, or containers 122.

An interface element presenter 111 can then present, on the user interface 123, the user interface sensory element configuration 120 selected from the user interface sensory element bundle 162 to provide the user 140 with a rich, expressive experience that caters to their preferred sensory inputs.

In one or more embodiments, the user interface sensory element configuration 120 selected form the user interface sensory element bundle 162 is enhanced as a function of a first combination of a visual appearance preferred by the authorized user 140 of the electronic device 100, an olfactory appearance preferred by the authorized user 140 of the electronic device 100, an aural appearance preferred by the authorized user 140 of the electronic device 100, a gustatory appearance preferred by the authorized user 140 of the electronic device 100, and a haptic appearance preferred by the authorized user 140 of the electronic device 100 and diminished as a second combination of the visual appearance preferred by the authorized user 140 of the electronic device 100, the olfactory appearance preferred by the authorized user 140 of the electronic device 100, the aural appearance preferred by the authorized user 140 of the electronic device 100, the gustatory appearance preferred by the authorized user 140 of the electronic device 100, and the haptic appearance preferred by the authorized user 140 of the electronic device 100. In one or more embodiments, the one or more modified user interface configurations comprise text 127 that is different from the one or more user interface elements.

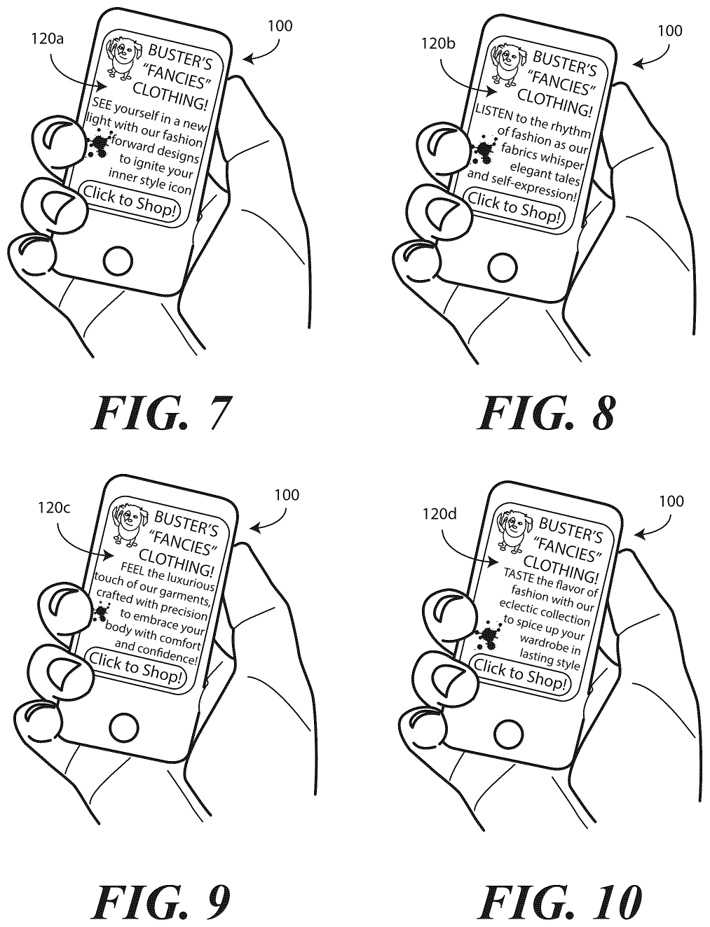

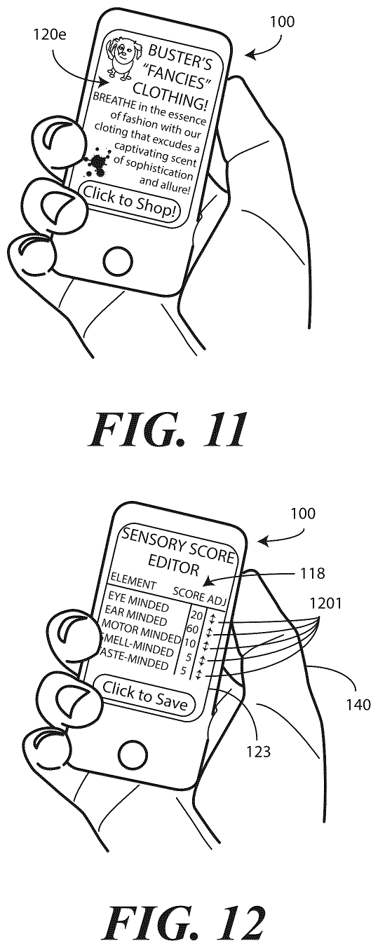

To illustrate by example, turn now to FIGS. 7-11. Illustrated in each figure is the electronic device 100 presenting a selected user interface sensory element configuration (120). In FIG. 7, a first selected user interface sensory element configuration 120a is being presented, while in FIG. 8 a second selected user interface sensory element configuration 120b is being presented. In FIG. 9, a third selected user interface sensory element configuration 120c is being presented, while a fourth selected user interface sensory element configuration 120d is being presented in FIG. 10. In FIG. 11, a fifth selected user interface sensory element configuration 120e is being presented.

Each selected user interface sensory element configuration 120a,120b,120c,120d,120e is an advertisement for Buter's Fancies Clothing. However, in other embodiments the selected user interface sensory element configurations 120a,120b,120c,120d,120e can take other forms. Illustrating by example, in one or more embodiments the selected user interface sensory element configurations 120a,120b,120c,120d,120e comprise user input controls. In other embodiments, the selected user interface sensory element configurations 120a,120b,120c,120d,120e comprise navigational elements. In still other embodiments, the selected user interface sensory element configurations 120a,120b,120c,120d,120e comprise containers.

Of course, these explanatory examples of selected user interface sensory element configurations 120a,120b,120c,120d,120e can be used in various combinations, with multiple selected user interface sensory element configurations 120a,120b,120c,120d,120e being presented on a user interface of the electronic device 100. Moreover, other examples of selected user interface sensory element configurations 120a,120b,120c,120d,120e will be obvious to those of ordinary skill in the art having the benefit of this disclosure.

In this illustrative example, each selected user interface sensory element configuration 120a,120b,120c,120d,120e comprises text that is different from each selected user interface sensory element configuration 120a,120b,120c,120d,120e. Importantly, the text results in each selected user interface sensory element configuration 120a,120b,120c,120d,120e catering to a particular sense, and enhancing a characteristic associated with at least one user sensory element and diminishing another characteristic associated with at least one other user sensory element.

The selected user interface sensory element configuration 120a of FIG. 7 caters to sight, asking the user to “SEE yourself in a new light,” which caters to a sight-based user sensory element. By contrast, the selected user interface sensory element configuration 120b of FIG. 8 asks the user to “LISTEN to the rhythm” of fashion as Buster's fabrics “whisper” elegant tales, thereby catering to an ear-based user sensory element.

The selected user interface sensory element configuration 120c of FIG. 9 caters to touch, asking the user to “FEEL the luxurious touch” of the garments that “embrace your body.” These descriptors or touch cater to a touch-based user sensory element. By contrast, the selected user interface sensory element configuration 120d of FIG. 10 asks the user to “TASTE the flavor of fashion” as Buster's fabrics “spice up” your wardrobe, thereby catering to an ear-based user sensory element.

In FIG. 11, the selected user interface sensory element configuration 120e asks the user to “BREATHE in” the essence of fashion by choosing clothing that “exudes a captivating scent” of sophistication and allure, thereby catering to a smell-based user sensory element. These examples are illustrative only, as numerous others will be obvious to those of ordinary skill in the art having the benefit of this disclosure.

Turning now back to FIG. 1, in one or more embodiments, the user sensory preference reaction score 118 is determined using a combination of scores corresponding to each of the senses. Illustrating by example, in one or more embodiments the user sensory preference reaction score 118 is determined using an eye-minded dominance score, a smell-minded dominance score, an ear-minded dominance score, a taste-minded dominance score, and a motor-minded dominance score. In one or more embodiments, the sensory perception score manager 102 normalizes the eye-minded dominance score, the smell-minded dominance score, the ear-minded dominance score, the taste-minded dominance score, and the motor-minded dominance score so that each heat spreader a value between one and negative one, inclusive.

In one or more embodiments, the sensory perception score manager 102 allows a user 140 to adjust the user sensory preference reaction score 118 by delivering user input 141 to the user interface 123. Illustrating by example, in one or more embodiments the sensory perception score manager 102 can present the user sensory preference reaction score 118 on the user interface 123. The user interface 123 can then receive user input 141 in response to this presentation. The sensory perception score manager 102 can then adjust one or more sensory element preference elements of the user sensory preference reaction score 118 as a function of the user input 141.

Turning briefly to FIG. 12, illustrated therein is the electronic device 100 presenting the user sensory preference reaction score 118 on the user interface 123. In this illustrative embodiment, the user sensory preference reaction score 118 has been broken down into sensory preference elements, namely, the eye-minded dominance score, the ear-minded dominance score, the motor-minded dominance score, the smell-minded dominance score, and the taste-minded dominance score so that the user 140 can see each individual score. By delivering user input (141) to adjustment user actuation targets 1201, the user 140 can adjust the one or more sensory preference elements so that the user sensory preference reaction score 118 is changed as a function of the user input.

Turning now back to FIG. 1, in one or more embodiments the interface element selector 130 can select the user interface sensory element configuration 120 from the user interface sensory element bundle 162 for presentation on the user interface 123 of the electronic device 100 as a function of a dominant sensory profile 119 associated with the user 140 of the electronic device 100. Thereafter, the interface element presenter 111 can present the selected user interface sensory element configuration 120 on the user interface 123, as was illustrated above in FIGS. 7-11. This presentation of the selected user interface sensory element configuration 120 enhances a characteristic associated with at least one user sensory preference element and diminishes another characteristic associated with at least one other user sensory preference element in one or more embodiments.

The executable software code used by the one or more processors 106 can be configured as one or more modules 113 that are operable with the one or more processors 106. Such modules 113 can store instructions, control algorithms, and so forth.

In one or more embodiments, these modules 113 identify high dominance and low dominance factors for each sense. In one or more embodiments, the sensory perception score manager 102 then, for each factor, calculates a score based upon user behavior. For instance, if a user always wears a noise canceling headset, even when that headset is not being used to deliver audio to the user, the sensory perception score manager 102 might calculate a low score for the ear-minded dominance score.

In one or more embodiments, the sensory perception score manager 102 considers weights. For instance, the sensory perception score manager 102 may multiply each of the eye-minded dominance score, the smell-minded dominance score, the ear-minded dominance score, the taste-minded dominance score, and the motor-minded dominance score by a weight since not all factors are the same. To illustrate by example, wearing a noise canceling headset may carry more weight in an ear-minded dominance score than does the fact that the user 140 actuates enhanced stereo sound from an audio output device of the other components 121.

Once this is complete, the sensory perception score manager 102 can sum all the scores to determine the user sensory preference reaction score 118. In one or more embodiments, the sensory perception score manager 102 normalizes the user sensory preference reaction score 118 to a value of between negative one and positive one to ensure scores can be compared against senses.

As noted above, in one or more embodiments the user sensory preference reaction score 118 is determined using an eye-minded dominance score, a smell-minded dominance score, an ear-minded dominance score, a taste-minded dominance score, and a motor-minded dominance score. In one or more embodiments, each of the eye-minded dominance score, smell-minded dominance score, ear-minded dominance score, taste-minded dominance score, and motor-minded dominance score can be normalized to have a value between one and negative one, inclusive.

In one or more embodiments, each of the eye-minded dominance score, smell-minded dominance score, ear-minded dominance score, taste-minded dominance score, and motor-minded dominance score is comprised of different factors, with some having higher weights than others. To illustrate a few examples, the higher factors for the eye-minded dominance score include high usage of video applications, actively changing wall papers and screen saver images, heavy use of high-definition and 4K resolution, and using hue lights on connected companion devices. These higher factors tend to demonstrate that the dominant sensory profile 119 caters to visual sensory perception. By contrast, lower factors for the eye-minded dominance score include actively lowering the brightness of the display, turning on a “dark only” color scheme, and failing to direct their gaze toward the display even when videos are playing. These lower factors tend to demonstrate that the dominant sensory profile 119 diminishes the importance of visual sensory perception.

Turning to the ear-minded dominance score, the higher factors indicating that the dominant sensory profile 119 cates to aural sensory perception include the user continually turning on audio enhancement features such as Dolby.sup.™ ATMOS.sup.™, the usage of high-end audio companion electronic devices, the use of noise canceling headsets, large consumption of audio content, and continually playing music on home companion electronic devices. Lower factors demonstrating that the dominant sensory profile 119 diminishes the importance of aural sensory perception include the fact that the volume setting is continually turned down, the fact that headsets or earbuds are almost never, or never, connected to the electronic device, the fact that a user wears a noise-canceling headset with no audio output, and the fact that a user plays games without any audio output.

Turning to the motor-minded dominance score, higher factors demonstrating that the dominant sensory profile 119 indicates that a person is touch motivated include having haptic features turned ON so that the devices buzzes and vibrates, the fact that “live” wallpapers are selected, the fact that the user continually fidgets with the electronic device, either spinning a candy bar device, continually opening and closing a hinged electronic device having a first device housing that is pivotable relative to a second device housing between an axially displaced open position and a closed position, or continually moving a slidable display, the fact that the user enjoys virtual reality applications and companion electronic devices, the fact that the user interacts with videos and images or actively seeks the consumption of video content, and the fact that the user continually uses the device while traveling. Lower factors indicating that the dominant sensory profile 119 is not sensitive to touch include the fact that the user has turned off all haptic devices or is not into gaming.

The examples of factors for three of the five minded dominance scores are illustrative only and are intended to provide information concerning how each of the eye-minded dominance score, smell-minded dominance score, ear-minded dominance score, taste-minded dominance score, and motor-minded dominance score can be calculated. Numerous others will be obvious to those of ordinary skill in the art having the benefit of this disclosure.

In one or more embodiments the one or more processors 106 are responsible for running the operating system environment 114. The operating system environment 114 can include a kernel, one or more drivers, and an application service layer 115, and an application layer 116. The operating system environment 114 can be configured as executable code operating on one or more processors or control circuits of the electronic device 100.

The application service layer 115 can be responsible for executing application service modules. The application service modules may support one or more applications 117 or “apps.”

Examples of such applications include a cellular telephone application for making voice telephone calls, a web browsing application configured to allow the user to view webpages on the display 101 of the electronic device 100, an electronic mail application configured to send and receive electronic mail, a photo application configured to organize, manage, and present photographs on the display 101 of the electronic device 100, and a camera application for capturing images with the imager 109. Collectively, these applications constitute an “application suite.” In one or more embodiments, these applications comprise one or more e-commerce applications 124 and/or shopping applications 125 that allow electronic commerce orders to be placed and financial transactions to be made using the electronic device 100.

In one or more embodiments, the one or more processors 106 are responsible for managing the applications and all personal information received from the user interface 123 that is to be used by the e-commerce application 124 and/or electronic shopping application 125 after the electronic device 100 is authenticated as a secure electronic device and the user identification credentials have triggered an electronic payment transaction request to complete an electronic shopping cart interaction event. The one or more processors 106 can also be responsible for launching, monitoring, and killing the various applications and the various application service modules. In one or more embodiments, the one or more processors 106 are operable to not only kill the applications, but also to expunge any and all personal data, data, files, settings, or other configuration tools when the electronic device 100 is reported stolen or when the e-commerce application 124 and/or electronic shopping application 125 are used with fraudulent activity to wipe the memory 112 clean of any personal data, preferences, or settings of the person previously using the electronic device 100.

The one or more processors 106 can also be operable with other components 121. The other components 121, in one embodiment, include input components, which can include acoustic detectors as one or more microphones. The one or more processors 106 may process information from the other components 121 alone or in combination with other data, such as the information stored in the memory 112 or information received from the user interface.

The other components 121 can include a video input component such as an optical sensor, another audio input component such as a second microphone, and a mechanical input component such as button. The other components 121 can include one or more sensors 126, which may include key selection sensors, touch pad sensors, capacitive sensors, motion sensors, and switches. Similarly, the other components 121 can include video, audio, and/or mechanical outputs.

The one or more sensors 126 may include, but are not limited to, accelerometers, touch sensors, surface/housing capacitive sensors, audio sensors, and video sensors. Touch sensors may be used to indicate whether the electronic device 100 is being touched at side edges. The other components 121 of the electronic device can also include a device interface to provide a direct connection to auxiliary components or accessories for additional or enhanced functionality and a power source, such as a portable battery, for providing power to the other internal components and allow portability of the electronic device 100.

In one or more embodiments, each of the sensory perception score manager 102, the interface element selector 130, and the interface element presenter 111 can be operable with one or more processors 106, configured as a component of the one or more processors 106, or configured as one or more executable code modules operating on the one or more processors 106. In other embodiments, the sensory perception score manager 102, the interface element selector 130, and the interface element presenter 111 can be standalone hardware components operating executable code or firmware to perform their functions. Other configurations for the sensory perception score manager 102, the interface element selector 130, and the interface element presenter 111 will be obvious to those of ordinary skill in the art having the benefit of this disclosure.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

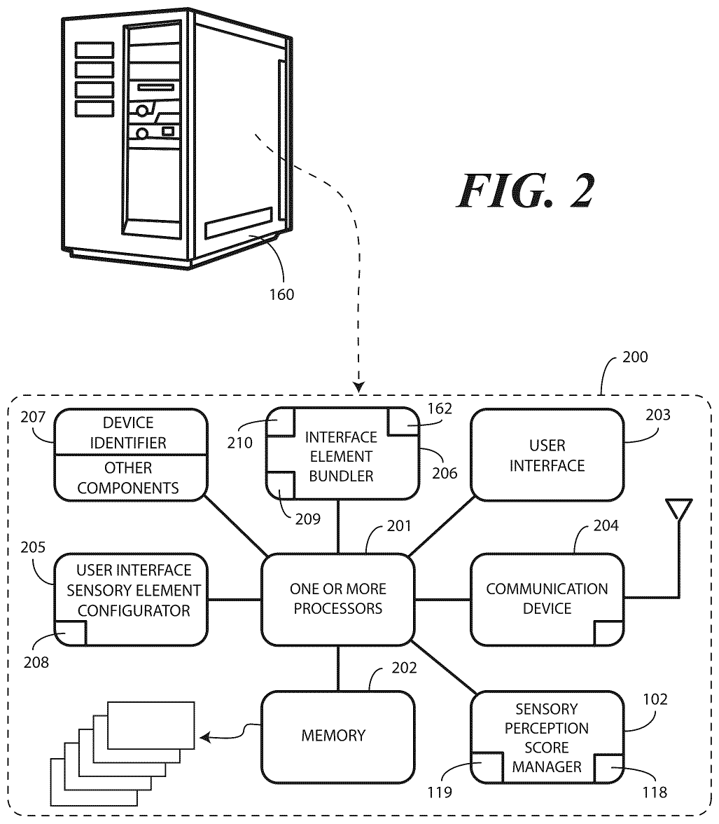

Turning now to FIG. 2, illustrated therein is one explanatory server complex 160 with which the electronic device (100) of FIG. 1 may communicate across a network (161). The server complex 160 is illustrated as a cloud server in FIG. 2. However, in other embodiments, the remote electronic device can be another type of computer, server, a server complex, network hub, or other computing device configured to authenticate one or more electronic devices as secure or trusted electronic devices.

An illustrative schematic block diagram 200 is also shown in FIG. 2. As with the block diagram schematic (150) of FIG. 1, it is to be understood that the schematic block diagram 200 of FIG. 2 is provided for illustrative purposes only and for illustrating components of one explanatory cloud server configured in accordance with one or more embodiments of the disclosure. Accordingly, the components shown in either FIG. 1 or FIG. 2 are not intended to be complete schematic diagrams of the various components required for a particular device, as other devices configured in accordance with embodiments of the disclosure may include various other components not shown in FIG. 1 or FIG. 2. Alternatively, other remote electronic devices configured in accordance with embodiments of the disclosure or may include a combination of two or more components or a division of a particular component into two or more separate components, and still be within the scope of the present disclosure.

In one or more embodiments, the server complex 160 includes one or more processors 201, one or more memory devices 202, and one or more user interface devices 203, e.g., a display, a keyboard, a mouse, audio input devices, audio output devices, and alternate visual output devices. The server complex 160 also includes a communication device 204. These components can be operatively coupled together such that, for example, the one or more processors 201 are operable with the one or more memory devices 202, the one or more user interface devices 203, and/or the communication device 204 in one or more embodiments.

The one or more processors 201 can include a microprocessor, a group of processing components, one or more ASICs, programmable logic, or other type of processing device. The one or more processors 201 can be configured to process and execute executable software code to perform the various functions of the server complex 160.

The one or more memory devices 202 can optionally store the executable software code used by the one or more processors 201 in carrying out the operations of authenticating electronic devices as secure or trusted electronic devices. The one or more memory devices 202 may include either or both of static and dynamic memory components, as well as one or more encrypted memory devices 202. The one or more memory devices 202 can store both embedded software code and user data.

The software code can embody program instructions and methods to determine whether a remote electronic device in communication with the communication device 204 is implementing a sensory element user interface presentation mode of operation, constructing a user interface sensory element bundle 162, and pushing transmission of the user interface sensory element bundle 162 to the remote electronic device. The software code can embody program instructions and methods to operate the various functions of the server complex 160, and also to execute software or firmware applications and modules such as the interface element bundler 206, the user interface sensory element configurator 205, and the device identifier 207. The server complex can even include a sensory perception score manager 102 that performs the functions of that component within the server complex 160 rather than in a remote electronic device in communication with the server complex 160, including determining the user sensory preference reaction score 118 and associating it with a dominant sensory profile 119 as previously described.

In one or more embodiments, the communication device 204 comprises any of a number of wired or wireless technologies for communication. Examples of these technologies include wired plain old telephone service (POTS) technologies, wired Ethernet technologies such as those configured in accordance with the IEEE 802.11 networking standards, peer-to-peer or ad hoc communications, frequency modulated communication, amplitude modulated communication, or IEEE 802.11 wireless communication. Other forms of communication technologies suitable for inclusion with the communication device 204 will be obvious to those having the benefit of this disclosure. The communication device 204 can include wired or wireless communication circuitry, one of a receiver, a transmitter, or transceiver. Where wireless, the communication device 204 can include one or more antennas.

In one or more embodiments, the communication device 204 is operable to establish electronic communication with an electronic device (100) across a network (161). In one or more embodiments, a device identifier 207 is then operable to determine whether the electronic device (100) is implementing a sensory element user interface presentation mode of operation. In one or more embodiments, the device identifier 207 also determines, using the communication device 204, whether the remote electronic device allows remote selection of a user interface sensory element configuration from the user interface sensory element bundle 162 as a function of a dominant sensory profile 119 associated with the user of the remote electronic device.

In one or more embodiments, the user interface sensory element configurator 205 can generate multiple versions of a user interface sensory element configuration 208 with each version of the user interface sensory element configuration 208 catering to different sensory preferences of a user. To which sensory preference or preferences each version of the user interface sensory element configuration 208 caters can be encoded into metadata 209 associated with the user interface sensory element bundle 162.

Illustrating by example, in one or more embodiments the user interface sensory element bundle 162 comprises a plurality of user interface sensory element configurations 210, as described above with reference to FIG. 1. In one or more embodiments, this plurality of user interface sensory element configurations 210 comprises an eye-minded user interface sensory element configuration, a smell-minded user interface sensory element configuration, an ear-minded user interface sensory element configuration, a taste-minded user interface sensory element configuration, and a motor-minded user interface sensory element configuration.

The dominant sensory profile 119 with which each user interface sensory element configuration is associated can be encoded into the metadata of the user interface sensory element bundle 162. Moreover, as noted above, in one or more embodiments each user interface sensory element configuration of the user interface sensory element bundle 162 comprises one or more of user input controls, navigational elements, and/or containers.

Where the plurality of user interface sensory element configurations 210 each comprise informational components comprising text, the text of each user interface sensory element configuration can have one or both of adjectives and/or adverbs in the text that differs from each other user interface sensory element configuration of the plurality of user interface sensory element configurations 210, as described above with reference to FIGS. 7-11. In one or more embodiments, those one or both of the adjectives and/or the adverbs enhance a characteristic associated with at least one user interface element and diminish another characteristic associated with at least one other user interface element. The adjectives and adverbs can also be encoded into the metadata 209 associated with each user interface sensory element configuration of the user interface sensory element bundle 162.

In some embodiments, such as when the remote electronic device in communication with the communication device allows the remote selection of the user interface sensory element configuration from the user interface sensory element bundle 162 as a function of the dominant sensory profile 119 associated with a user of the remote electronic device, the sensory perception score manager 102 can retrieve the user sensory preference reaction score 118 from a user profile stored in a memory of the remote electronic device and can select the user interface sensory element configuration from the user interface sensory element bundle 162 for selective delivery to the remote electronic device as a function of the dominant sensory profile 119 associated with the user of the remote electronic device. In some instances, the interface element bundler 206 can even cause the one or more processors of the remote electronic device to present the user interface sensory element configuration selected from the user interface sensory element bundle 162. This optional mode of operation effectively allows the server complex 160 to perform the selection and presentation function, thereby controlling the remote electronic device effectively as a terminal device. This mode of operation can be effective when the remote electronic device is a display device with limited processing power, for example. Of course, when a new user is detected using the remote electronic device, the process can repeat as previously described.

In one or more embodiments the server complex 160 can be configured for performing processor-intensive methods, operations, steps, functions, or procedures associated with, in response to the communication device 204 determining that a remote electronic device in communication with the communication device 204 across a network is implementing a sensory element user interface presentation mode of operation, utilize the interface element bundler 206 to compile a plurality of user interface sensory element configurations 210 contained in a user interface sensory element bundle 162 from which a user interface sensory element configuration can be selected as a function of a dominant sensory profile 119 associated with an authorized user of the remote electronic device, and causing the communication device 204 to transmit the user interface sensory element bundle 162 to the remote electronic device across the network.

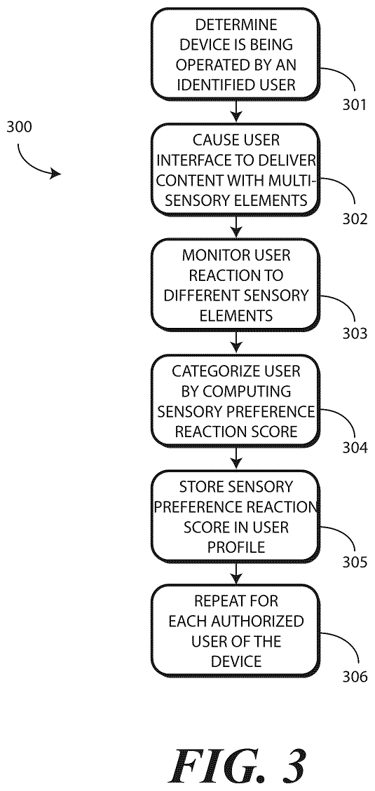

Turning now to FIG. 3, illustrated therein is one explanatory method 300 in accordance with one or more embodiments of the disclosure. The method 300 is suitable, for example, to operate in the electronic device (100) of FIG. 1. In other embodiments, the method 300 could be implemented by the cloud server complex (160) shown in communication with the electronic device (100) of FIG. 1 across a network (161). Other configurations for executing the method 300 of FIG. 3 will be obvious to those of ordinary skill in the art having the benefit of this disclosure.

Beginning at step 301, one or more sensors of an electronic device identify an authorized user of the electronic device using the electronic device. At step 302, one or more processors of the electronic device present, on a user interface, a plurality of user interface elements. In one or more embodiments, each user interface element of the plurality of user interface elements includes components catering to a different sensory perception from other user interface elements of the plurality of user interface elements.

At step 303, the method 300 measures, using one or more sensors, reactions of the authorized user of the electronic device to the plurality of user interface elements. At step 304, the method 300 determines, from the reactions, a user sensory preference reaction score.

In one or more embodiments, the user sensory preference reaction score is determined using an eye-minded dominance score, a smell-minded dominance score, an ear-minded dominance score, a taste-minded dominance score, and a motor-minded dominance score, as noted above. In one or more embodiments, each of the eye-minded dominance score, the smell-minded dominance score, the ear-minded dominance score, the taste-minded dominance score, and the motor-minded dominance score is normalized at step 304 to have a value of between one and negative one, inclusive.

In one or more embodiments, the user sensory preference reaction score determined at step 304 is also associated with a dominant sensory profile associated with the authorized user of the electronic device. At step 305, one or both of the user sensory preference reaction score and/or dominant sensory profile can be stored in a memory of the electronic device with a user profile belonging to the authorized user of the electronic device.

Step 306 then repeats the method 300 each time a different user is detected using the electronic device. Accordingly, in one or more embodiments step 306 comprises one or more sensors detecting another user using the electronic device, repeating the presentation of step 302, measuring other reactions similar to step 303, and determining another user sensory preference reaction score as in step 304. Step 306 can then comprise associating the other user sensory preference reaction score with another display associated with the other user and storing that dominant sensory profile and/or user sensory preference reaction score in the memory as in step 305.

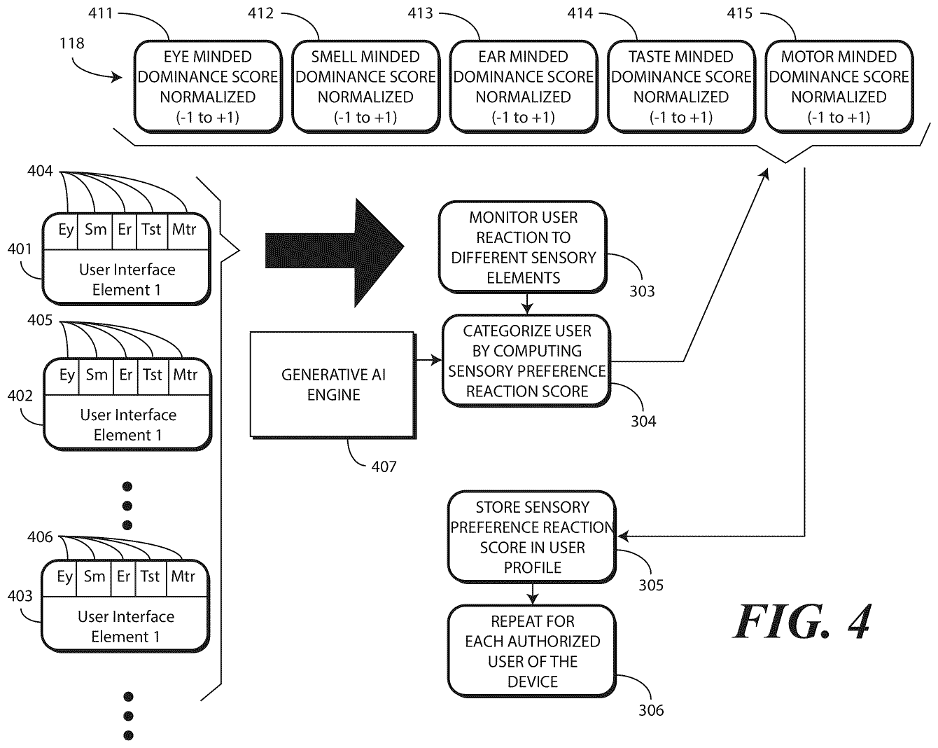

Turning now to FIG. 4, illustrated therein is a system flow diagram showing how the user sensory preference reaction score can be calculated. As shown, a plurality of user interface elements 401,402,403 are presented to a user on a user interface. Each user interface element of the plurality of user interface elements 401,402,403 caters to components 404,405,406 different sensory perceptions than do other user interface element of the plurality of user interface elements 401,402,403.

At step 303, one or more sensors of an electronic device can measure reactions of a user to the plurality of user interface elements 401,402,403. Step 304, which can optionally be performed using the assistance of a generative artificial intelligence engine 407, determine the user sensory preference reaction score 118.

In this illustrative embodiment, the user sensory preference reaction score 118 is determined using an eye-minded dominance score 411, a smell-minded dominance score 412, an ear-minded dominance score 413, a taste-minded dominance score 414, and a motor-minded dominance score 415, each of which is normalized to have a value of between one and minus one, inclusive. Step 305 and step 306 are then performed as described above with reference to FIG. 3.

As graphically illustrated in FIG. 4, in one or more embodiments a method comprises presenting, by one or more processors on a user interface, a plurality of user interface elements 401,402,403. In one or more embodiments each user interface element of the plurality of user interface elements 401,402,403 includes components 404,405,406 catering to different sensory perceptions from other user interface elements of the plurality of user interface elements 401,402,403. Step 303 then comprises measuring, by one or more sensors, reactions of a user of the electronic device to the plurality of user interface elements 401,402,403. Step 304 determines, by the one or more processors from the reactions, a user sensory preference reaction score 118. Step 305 then stores the user sensory preference reaction score in a memory of the electronic device. When combined with the feature described above with reference to FIG. 12, the system of FIG. 4 can also adjust, by the one or more processors, the user sensory preference reaction score 118 in response to user input received at the user interface.

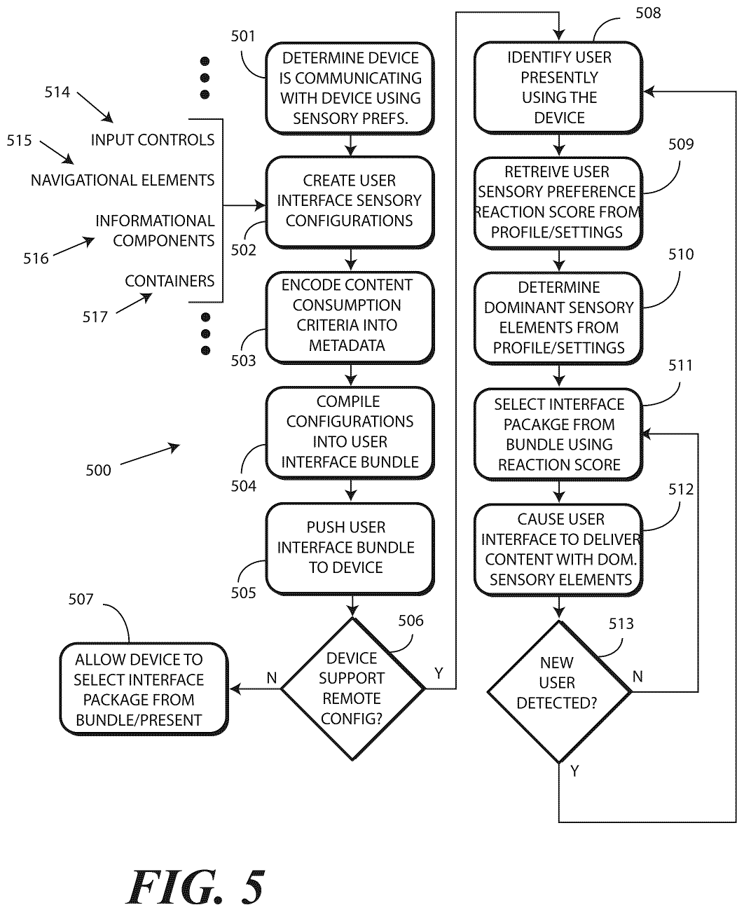

Turning now to FIG. 5, illustrated therein is one explanatory method for a sending device, one example of which is the server complex (160) described above with reference to FIGS. 1 and 3. Beginning at step 501, the method 500 determines, using a communication device, that the electronic device in which the method 500 is being implemented is in communication with a remote electronic device across a network implementing a sensory element user interface presentation mode of operation. In one or more embodiments, step 501 comprises determining, using one or more processors and the communication device, whether the remote electronic device allows remote selection of a user interface sensory element configuration from a user interface sensory element bundle that is delivered to the remote electronic device using the communication device as a dominant sensory profile associated with a user of the remote electronic device.

Step 502 creates, using one or more processors, a plurality of user interface sensory element configurations each enhancing a different sensory appearance when rendered on the remote electronic device. In one or more embodiments, the user interface sensory element configurations created at step 502 comprise an eye-minded user interface sensory element configuration, a smell-minded user interface sensory element configuration, an ear-minded user interface sensory element configuration, a taste-minded user interface sensory element configuration, and a motor-minded user interface sensory element configuration. As shown in FIG. 5, in one or more embodiments each user interface sensory element configuration comprises one or more of input controls 514, navigational elements 515, informational components 516, and/or containers 517.

As illustrated above with reference to FIGS. 7-11, in one or more embodiments each user interface sensory element configuration created at step 502 comprises text that is different from any other user interface sensory element configuration. Illustrating by example, a first user interface sensory element configuration created at step 502 is enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and is diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device.

At step 503, the method 500 writes, using one or more processors, an enhanced sensory appearance to metadata of each user interface sensory element configuration created at step 502. In one or more embodiments, step 503 comprises writing, by the one or more processors to the metadata, a dominant sensory profile associated with the each user interface sensory element configuration of the plurality of user interface sensory element configurations.

Step 504 then compiles the plurality of user interface sensory element configurations created at step 502 into a user interface sensory element bundle. Step 505 then pushes, using a communication device, the user interface sensory element bundle to one or more remote electronic devices across a network.

Decision 506 determines whether the remote electronic device allows remote configuration. Said differently, in one or more embodiments decision 506 comprises determining whether the remote electronic device(s) to which the user interface sensory element bundle is delivered allow the remote selection of a user interface sensory element configuration form the user interface sensory element bundle as a function of a dominant sensory profile associated with a user of the electronic device.

When it does not, step 507 comprises allowing the one or more processors of the remote electronic device(s) to which the user interface sensory element bundle is delivered to select a user interface sensory element configuration from a plurality of user interface sensory element configurations contained in a user interface sensory element bundle received by the communication device as a function of a dominant sensory profile associated with an authorized user of the electronic device and, thereafter, cause the user interface to present the user interface sensory element configuration selected from the plurality of user interface sensory element configurations contained in a user interface sensory element bundle.

However, if the remote electronic device(s) to which the user interface sensory element bundle is delivered allow remote configuration, step 508 can comprise identifying a user of the remote electronic device(s). Step 509 can then comprise retrieving, using one or more processors, a user sensory preference reaction score from a user profile stored in a memory of the electronic device. Step 510 can determine a dominant sensory profile from the user sensory preference reaction score.

Step 511 can then select, using the one or more processors, a user interface sensory element configuration from the user interface sensory element bundle as a function of the dominant sensory profile associated with the user of the electronic device. In other embodiments, step 511 can comprise obtaining, using a communication device, the dominant sensory profile associated with the authorized user of the electronic device and select a user interface sensory element configuration from the plurality of user interface sensory element configurations contained in the user interface sensory element bundle.

Step 512 can then cause a user interface of the remote electronic device to present the user interface sensory element configuration selected from the user interface sensory element bundle. Said differently, in one or more embodiments step 512 comprises one or more processors causing, using the communication device, the remote electronic device to render the user interface sensory element configuration selected from the plurality of user interface sensory element configurations contained in the user interface sensory element bundle.

Decision 513 determines whether the user of the electronic device changes. Where it does, the method 500 can repeat. Illustrating by example, the method 500 can select another user interface sensory element configuration from the user interface sensory element bundle as a function of another dominant sensory profile associated with another user of the remote electronic device and can cause the user interface of the remote electronic device to present the other user interface sensory element configuration selected from the user interface sensory element bundle.

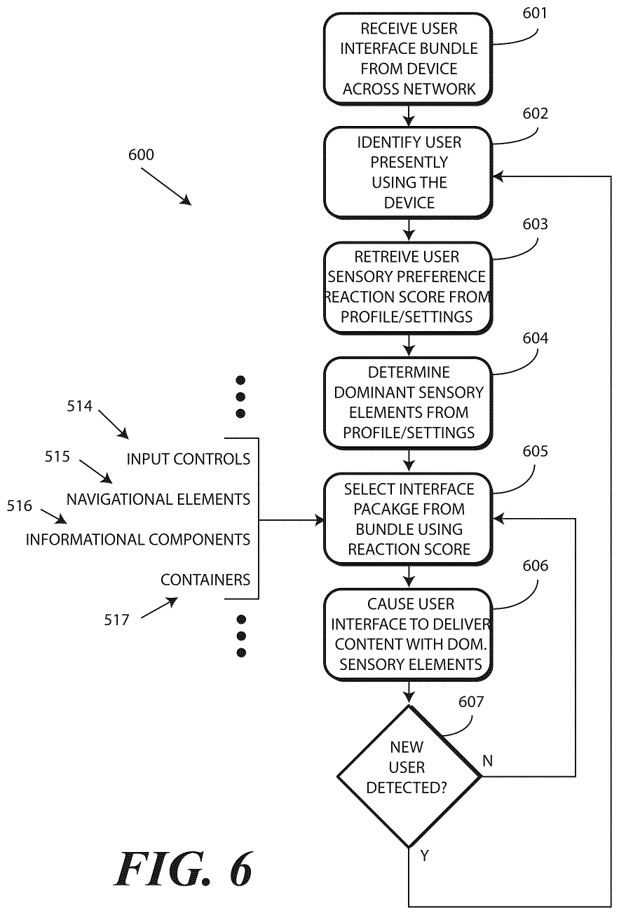

Turning now to FIG. 6, illustrated therein is a method 600 suitable for use in a receiving device, one example of which was described above with reference to FIG. 1. Beginning at step 601, a communication device receives, from a remote electronic device across a network, a user interface sensory element bundle. Step 602 then identifies, using one or more sensors of the electronic device, a user using the electronic device.

Step 603 comprises determining a user sensory preference reaction score. In one or more embodiments, this comprises retrieving a user sensory preference reaction score from a user profile stored in a memory of the electronic device. In other embodiments, step 603 comprises presenting, by one or more processors of the electronic device on a user interface, a plurality of user interface elements with each user interface element of the plurality of user interface elements including components catering to different sensory perceptions from other user interface element of the plurality of user interface elements. Step 603 can then comprise measuring, using one or more sensors, reactions of the user of the electronic device to the plurality of user interface elements and determining, by the one or more processors from the reactions, the user sensory preference reaction score.

Step 604 then determines a dominant sensory profile associated with the user of the electronic device. In one or more embodiments, step 604 determines the dominant sensory profile associated with the user of the electronic device by retrieving the user sensory preference reaction score from the user profile stored in the memory of the electronic device.

Step 605 then selects, using one or more processors, a user interface sensory element configuration from the user interface sensory element bundle received at step 601 as a function of one or more of the user sensory preference reaction score and/or the user interface sensory element bundle. As before, the selected user interface sensory element configuration can comprise one or more of input controls 514, navigational elements 515, informational components 516, and/or containers 517.

In one or more embodiments, the user interface sensory element configuration selected at step 605 is enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device. Illustrating by example, the user interface sensory element configuration selected from the plurality of user interface sensory element configurations contained in the user interface sensory element bundle at step 605 can comprise text that is different from any other user interface sensory element configuration contained in the plurality of user interface sensory element configurations contained in the user interface sensory element bundle. Step 606 then presents the user interface sensory element configuration selected from the user interface sensory element bundle on a user interface of the electronic device.

Decision 607 then determines whether the user of the electronic device changes. When it does, the method 600 can repeat. Illustrating by example, when the user changes the method 600 can repeat the presenting the plurality of user interface elements, measure other reactions of the other user of the electronic device to the plurality of user interface elements, and determine, by the one or more processors from the other reactions, another user sensory preference reaction score, as well as performing other steps.

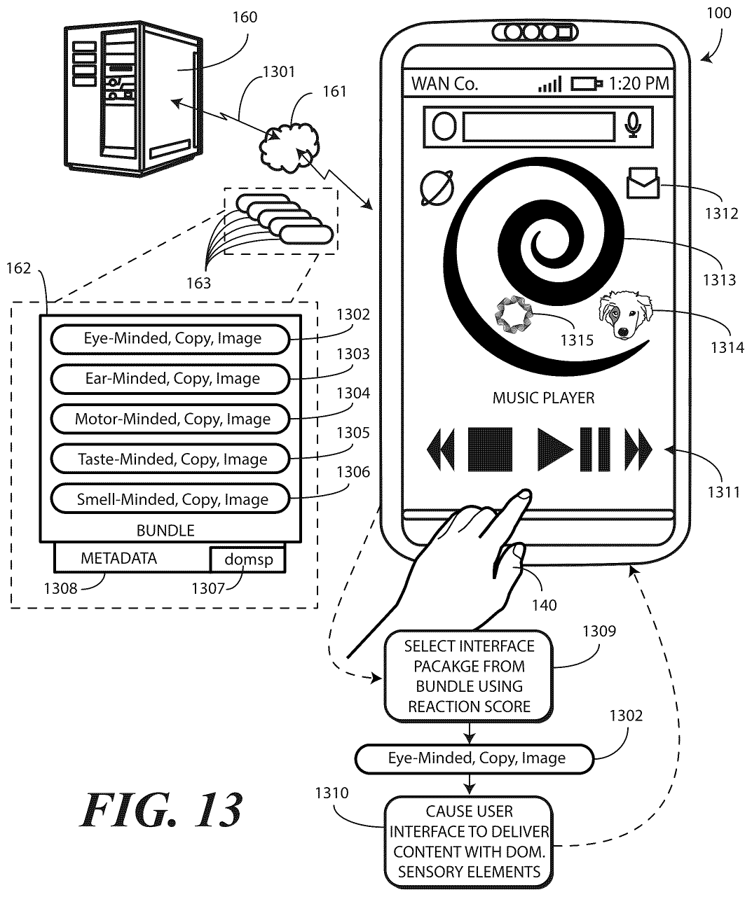

The combined operation of the method (500) of FIG. 5 and the method 600 of FIG. 6 can be seen occurring graphically in FIG. 13. Turning now to FIG. 13, illustrated therein is a server complex 160 and an electronic device 100 in communication with the server complex 160 across a network 161.

In one or more embodiments, the server complex 160 determines, with a communication device, that the server complex 160 is in communication 1301, across a network 161, with an electronic device 100 implementing a sensory element user interface presentation mode of operation. In one or more embodiments, one or more processors of the server complex 160 construct a user interface sensory element bundle 162. In one or more embodiments, the communication device of the server complex 160 then pushes transmission of the user interface sensory element bundle 162 to the electronic device 100. As before, the user interface sensory element bundle 162 comprises a plurality of user interface sensory element configurations 163.

In the illustrative embodiment of FIG. 13, the plurality of user interface sensory element configurations 163 comprise an eye-minded user interface sensory element configuration 1302, a smell-minded user interface sensory element configuration 1303, an ear-minded user interface sensory element configuration 1304, a taste-minded user interface sensory element configuration 1305, and a motor-minded user interface sensory element configuration 1306. A dominant sensory profile 1307 is encoded into metadata 1308 of each user interface sensory element configuration contained in the user interface sensory element bundle 162.

As also shown in FIG. 13, the electronic device 100 receives, using a communication device from the server complex 160, the user interface sensory element bundle 162. One or more sensors of the electronic device 100 can identify a user 140 of the electronic device 100. The one or more processors can also determine a dominant sensory profile associated with the user 140 of the electronic device.

At step 1309, the one or more processors of the electronic device 100 select a user interface sensory element configuration from the user interface sensory element bundle 162 as a function of the dominant sensory profile associated with the user 140 of the electronic device 100. In this illustrative example, the one or more processors select the eye-minded user interface sensory element configuration 1302. At step 1310, the one or more processors cause the user interface of the electronic device 100 to present the user interface sensory element configuration 1302 selected from the user interface sensory element bundle 162.

As noted above, in one or more embodiments the selected user interface sensory element configuration 1302 comprises one or more of user interface controls 1311, navigational elements 1312, or containers. Since the selected user interface sensory element configuration is the eye-minded user interface sensory element configuration 1302, the user interface presents moving spirals 1313 with dancing images 1314,1315 that mesmerize the eyes of the user 140. As such, the user 140 experiences a personalized, beautiful user interface experience that caters to their preferred sensory desires.

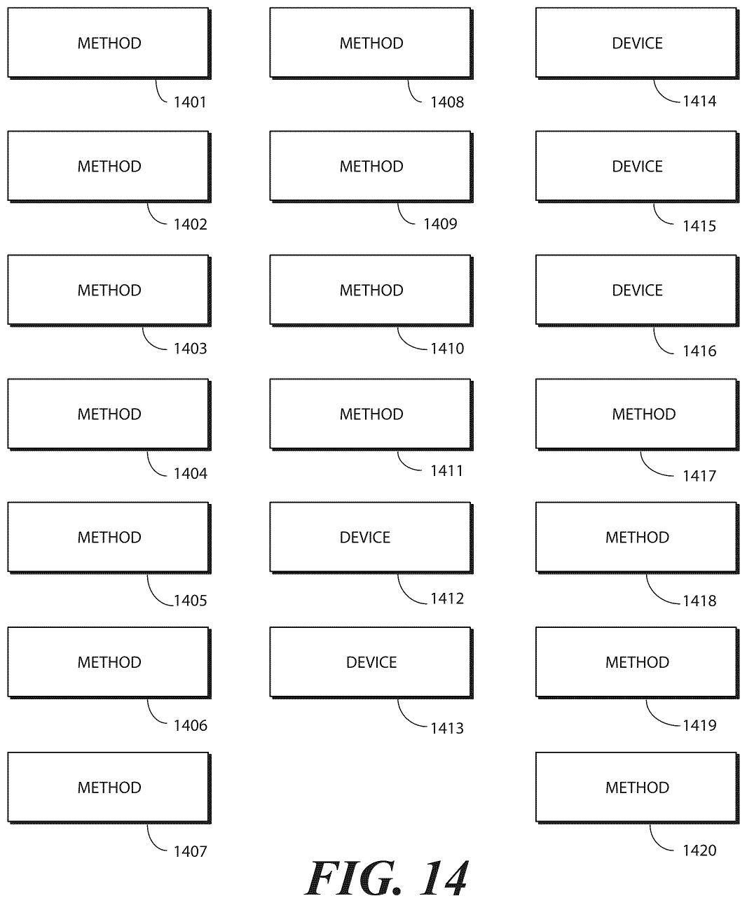

Turning now to FIG. 14, illustrated therein are various embodiments of the disclosure. The embodiments of FIG. 14 are shown as labeled boxes in FIG. 14 due to the fact that the individual components of these embodiments have been illustrated in detail in FIGS. 1-13, which precede FIG. 14. Accordingly, since these items have previously been illustrated and described, their repeated illustration is no longer essential for a proper understanding of these embodiments. Thus, the embodiments are shown as labeled boxes.

At 1401, a method in an electronic device comprises determining, with a communication device, that the electronic device is in communication, across a network, with a remote electronic device implementing a sensory element user interface presentation mode of operation. At 1401, the method comprises constructing, with one or more processors, a user interface sensory element bundle. At 1401, the method comprises pushing, with the communication device, transmission of the user interface sensory element bundle to the remote electronic device.

At 1402, the user interface sensory element bundle of 1401 comprises a plurality of user interface sensory element configurations. At 1403, the method of 1402 further comprises encoding a dominant sensory profile into metadata of each user interface sensory element configuration contained in the user interface sensory element bundle.

At 1404, the plurality of user interface sensory element configurations of 1402 comprises an eye-minded user interface sensory element configuration, a smell-minded user interface sensory element configuration, an ear-minded user interface sensory element configuration, a taste-minded user interface sensory element configuration, and a motor-minded user interface sensory element configuration. At 1405, each user interface sensory element configuration of the user interface sensory element bundle comprises one or more of user input controls, navigational elements, and/or containers.

At 1406, the plurality of user interface sensory element configurations of 1404 each comprise informational components in comprising text. At 1406, the text of each user interface sensory element configuration has one or both of adjectives and/or adverbs in the text that differs from each other user interface sensory element configuration of the plurality of user interface sensory element configurations, with those one or both of the adjectives and/or the adverbs enhancing a characteristic associated with at least one user interface element and diminishing another characteristic associated with at least one other user interface element.

At 1407, one or both of the adjectives and/or adverbs of 1406 are encoded into metadata associated with each sensory element configuration. At 1408, the method of 1404 further comprises determining, by the one or more processors using the communication device, whether the remote electronic device allows remote selection of a user interface sensory element configuration from the user interface sensory element bundle as a function of a dominant sensory profile associated with the user of the remote electronic device.

At 1409, when the remote electronic device of 1408 allows the remote selection of the user interface sensory element configuration from the user interface sensory element bundle as the function of the dominant sensory profile associated with the user of the remote electronic device, the method further comprises retrieving, by the one or more processors, a user sensory preference reaction score from a user profile stored in a memory of the remote electronic device, and selecting, by the one or more processors, the user interface sensory element configuration from the user interface sensory element bundle as the function of the dominant sensory profile associated with a user of the remote electronic device.

At 1410, the method of 1409 further comprises causing, by the one or more processors, a user interface of the remote electronic device to present the user interface sensory element configuration selected from the user interface sensory element bundle. At 1411, the method of 1410 further comprises, when the one or more processors detect another user using the remote electronic device, selecting, by the one or more processors, another user interface sensory element configuration from the user interface sensory element bundle as the function of another dominant sensory profile associated with the another user of the remote electronic device and causing, by the one or more processors, the user interface of the remote electronic device to present the another user interface sensory element configuration selected from the user interface sensory element bundle.

At 1412, an electronic device comprises a communication device and one or more processors operable with the communication device. At 1412, the one or more processors are configured to, in response to the communication device determining that a remote electronic device in communication with the communication device across a network is implementing a sensory element user interface presentation mode of operation, compile a plurality of user interface sensory element configurations contained in a user interface sensory element bundle from which a user interface sensory element configuration can be selected as a function of a dominant sensory profile associated with an authorized user of the electronic device, and cause the communication device to transmit the user interface sensory element bundle to the remote electronic device across the network.

At 1413, each user interface sensory element configuration of the plurality of user interface sensory element configurations of 1412 contained in the user interface sensory element bundle comprises text that is different from any other user interface sensory element configuration contained in the plurality of user interface sensory element configurations contained in the user interface sensory element bundle. At 1414, a first user interface sensory element configuration of the plurality of user interface sensory element configurations contained in the user interface sensory element bundle of 1412 is enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device.

At 1415, the plurality of user interface sensory element configurations of 1412 comprises an eye-minded user interface sensory element configuration, a smell-minded user interface sensory element configuration, an ear-minded user interface sensory element configuration, a taste-minded user interface sensory element configuration, and a motor-minded user interface sensory element configuration. At 1415, a corresponding dominant sensory profile is written to metadata of each user interface sensory element configuration.

At 1416, the one or more processors of 1412 are further configured to obtain, using the communication device, the dominant sensory profile associated with the authorized user of the electronic device. At 1416, the one or more processors then select a user interface sensory element configuration from the plurality of user interface sensory element configurations contained in the user interface sensory element bundle. At 1417, the one or more processors of 1416 are further configured to cause, using the communication device, the remote electronic device to render the user interface sensory element configuration selected from the plurality of user interface sensory element configurations contained in the user interface sensory element bundle.

At 1418, a method in an electronic device comprises creating, using one or more processors, a plurality of user interface sensory element configurations each enhancing a different sensory appearance when rendered on a remote electronic device. At 1418, the method comprises writing, by the one or more processors, an enhanced sensory appearance to metadata of each user interface sensory element configuration of the plurality of user interface sensory element configurations.

At 1418, the method comprises compiling, by the one or more processors, the plurality of user interface sensory element configurations into a user interface sensory element bundle. AT 1418, the method comprises pushing, by a communication device, the user interface sensory element bundle to one or more remote electronic devices across a network.

At 1419, the method of 1418 further comprises writing, by the one or more processors to the metadata, a dominant sensory profile associated with each user interface sensory element configuration of the plurality of user interface sensory element configurations. At 1420, the method of 1419 further comprises causing, by the one or more processors, the one or more remote electronic devices to render a user interface sensory element configuration selected from the user interface sensory element bundle.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, consider that the Taranowski fan is a big fan of Motorola Mobility.sup.™ products. They are interested in checking out any flagship device from this favorite brand.

Now imagine that it is Christmas season and Motorola Mobility is launching the new RAZR ULTRA.sup.™. The device is a visual marvel, sounds great with Dolby ATMOS.sup.™ audio and has a great externa display with awesome graphics capabilities. An advertising blitz for the RAZR ULTRA.sup.™ begins.

With prior art devices, each member of the Taranowski family will receive the same campaign as a push notification. Since each member has different sensory preferences, the campaign may fall flat. Mrs. Taranowski is not impressed due to the fact that she cannot tolerate the sensory overload of the campaign. There are too many verbal gymnastics happening in the copy and too much motion on the image. By contrast, the kids love the word play and over the top images. Mr. Taranowski likes some portions of the campaign, but dislikes others and fails to watch the entire advertisement. With such prior art devices, four different people receive a campaign, but only two are interested in clicking “learn more.” This is not satisfactory.

Advantageously, using embodiments of the disclosure, each Taranowski device would receive a user interface sensory element bundle rather than a single campaign. Their respective devices would identify users, determine a dominant sensory profile associated with that user, select a user interface sensory element configuration from the user interface sensory element bundle as a function of the dominant sensory profile, and present the selected user interface sensory element configuration on the user interface of the electronic device. Thus, each member would get a different campaign specifically tailored to their sensory preferences. A four out of four click to “learn more” would be a complete slam dunk.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
determining, with a communication device, that the electronic device is in communication, across a network, with a remote electronic device implementing a sensory element user interface presentation mode of operation;
constructing, with one or more processors, a user interface sensory element bundle; and
pushing, with the communication device, transmission of the user interface sensory element bundle to the remote electronic device.

2. The method of claim 1, wherein the user interface sensory element bundle comprises a plurality of user interface sensory element configurations.

3. The method of claim 2, further comprising encoding a dominant sensory profile into metadata of each user interface sensory element configuration contained in the user interface sensory element bundle.

4. The method of claim 2, wherein the plurality of user interface sensory element configurations comprises:
an eye-minded user interface sensory element configuration;
a smell-minded user interface sensory element configuration;
an ear-minded user interface sensory element configuration;
a taste-minded user interface sensory element configuration; and
a motor-minded user interface sensory element configuration.

5. The method of claim 4, wherein each user interface sensory element configuration of the user interface sensory element bundle comprises one or more of:
user input controls;
navigational elements; and/or
containers.

6. The method of claim 4, wherein:
the plurality of user interface sensory element configurations each comprise informational components in comprising text; and
the text of each user interface sensory element configuration has one or both of adjectives and/or adverbs in the text that differs from each other user interface sensory element configuration of the plurality of user interface sensory element configurations, with those one or both of the adjectives and/or the adverbs enhancing a characteristic associated with at least one user interface element and diminishing another characteristic associated with at least one other user interface element.

7. The method of claim 6, wherein the one or both of the adjectives and/or the adverbs are encoded into metadata associated with each sensory element configuration.

8. The method of claim 4, further comprising determining, by the one or more processors using the communication device, whether the remote electronic device allows remote selection of a user interface sensory element configuration from the user interface sensory element bundle as a function of a dominant sensory profile associated with the user of the remote electronic device.

9. The method of claim 8, wherein when the remote electronic device allows the remote selection of the user interface sensory element configuration from the user interface sensory element bundle as the function of the dominant sensory profile associated with the user of the remote electronic device, the method further comprises:
retrieving, by the one or more processors, a user sensory preference reaction score from a user profile stored in a memory of the remote electronic device; and
selecting, by the one or more processors, the user interface sensory element configuration from the user interface sensory element bundle as the function of the dominant sensory profile associated with a user of the remote electronic device.

10. The method of claim 9, further comprising causing, by the one or more processors, a user interface of the remote electronic device to present the user interface sensory element configuration selected from the user interface sensory element bundle.

11. The method of claim 10, further comprising, when the one or more processors detect another user using the remote electronic device:
selecting, by the one or more processors, another user interface sensory element configuration from the user interface sensory element bundle as the function of another dominant sensory profile associated with the another user of the remote electronic device; and
causing, by the one or more processors, the user interface of the remote electronic device to present the another user interface sensory element configuration selected from the user interface sensory element bundle.

12. An electronic device, comprising:
a communication device; and
one or more processors operable with the communication device;
wherein the one or more processors are configured to, in response to the communication device determining that a remote electronic device in communication with the communication device across a network is implementing a sensory element user interface presentation mode of operation, compile a plurality of user interface sensory element configurations contained in a user interface sensory element bundle from which a user interface sensory element configuration can be selected as a function of a dominant sensory profile associated with an authorized user of the electronic device, and cause the communication device to transmit the user interface sensory element bundle to the remote electronic device across the network.

13. The electronic device of claim 12, wherein each user interface sensory element configuration of the plurality of user interface sensory element configurations contained in the user interface sensory element bundle comprises text that is different from any other user interface sensory element configuration contained in the plurality of user interface sensory element configurations contained in the user interface sensory element bundle.

14. The electronic device of claim 12, wherein a first user interface sensory element configuration of the plurality of user interface sensory element configurations contained in the user interface sensory element bundle is enhanced as a function of a first combination of a visual appearance preferred by the authorized user of the electronic device, an olfactory appearance preferred by the authorized user of the electronic device, an aural appearance preferred by the authorized user of the electronic device, a gustatory appearance preferred by the authorized user of the electronic device, and a haptic appearance preferred by the authorized user of the electronic device and diminished as a second combination of the visual appearance preferred by the authorized user of the electronic device, the olfactory appearance preferred by the authorized user of the electronic device, the aural appearance preferred by the authorized user of the electronic device, the gustatory appearance preferred by the authorized user of the electronic device, and the haptic appearance preferred by the authorized user of the electronic device.

15. The electronic device of claim 12, wherein the plurality of user interface sensory element configurations comprises:
an eye-minded user interface sensory element configuration;
a smell-minded user interface sensory element configuration;
an ear-minded user interface sensory element configuration;
a taste-minded user interface sensory element configuration; and
a motor-minded user interface sensory element configuration; and
wherein a corresponding dominant sensory profile is written to metadata of each user interface sensory element configuration.

16. The electronic device of claim 12, wherein the one or more processors are further configured to obtain, using the communication device, the dominant sensory profile associated with the authorized user of the electronic device and select a user interface sensory element configuration from the plurality of user interface sensory element configurations contained in the user interface sensory element bundle.

17. The electronic device of claim 16, wherein the one or more processors are further configured to cause, using the communication device, the remote electronic device to render the user interface sensory element configuration selected from the plurality of user interface sensory element configurations contained in the user interface sensory element bundle.

18. A method in an electronic device, the method comprising:
creating, using one or more processors, a plurality of user interface sensory element configurations each enhancing a different sensory appearance when rendered on a remote electronic device;
writing, by the one or more processors, an enhanced sensory appearance to metadata of each user interface sensory element configuration of the plurality of user interface sensory element configurations;
compiling, by the one or more processors, the plurality of user interface sensory element configurations into a user interface sensory element bundle; and
pushing, by a communication device, the user interface sensory element bundle to one or more remote electronic devices across a network.

19. The method of claim 18, further comprising writing, by the one or more processors to the metadata, a dominant sensory profile associated with the each user interface sensory element configuration of the plurality of user interface sensory element configurations.

20. The method of claim 19, further comprising causing, by the one or more processors, the one or more remote electronic devices to render a user interface sensory element configuration selected from the user interface sensory element bundle.
